(19) United States
(12) Patent Application Publication
(10) Pub. No.: US 2012/0176872 A1
(43) Pub. Date: Jul. 12, 2012

(54) Continuous Playback on an Optical Media Disc Player

(75) Inventor: Nigel Waites, Lakeville, MN (US)

(73) Assignee: BBY SOLUTIONS, INC., Richfield, MN (US)

(21) Appl. No.: 13/153,593

(22) Filed: Jun. 6, 2011

Related U.S. Application Data
(60) Provisional application No. 61/362,202, filed on Jul. 7, 2010.

(51) Int. Cl. G11B 7/0037

(52) U.S. Cl. 369/1; G9B/7.005

(57) ABSTRACT

An optical media player is described that submits identifying information from an optical disc to network media servers in order to stream related music through the media player upon completion of the music on the optical disc.

### FIELD OF THE INVENTION

The present application relates to the field of optical disc music players, such as devices that play compact discs (CDs). More particularly, the described embodiments relate to optical music players that submit identifying information from the optical disc to network media servers in order to stream related music through the media player upon completion of the music on the optical disc.

### BRIEF DESCRIPTION OF THE DRAWINGS

FIG. 1 is a schematic diagram of an embodiment of the present invention in communication with a music service server.

FIG. 2 is a flow chart showing a process continuous playback of songs based on the music on an optical disc.

FIG. 3 is a schematic diagram of a second embodiment of the present invention in communication with a video service server.

FIG. 4 is a schematic diagram of a third embodiment of the present invention in communication with a portable computing device having a network interface and a media service server.

### DETAILED DESCRIPTION

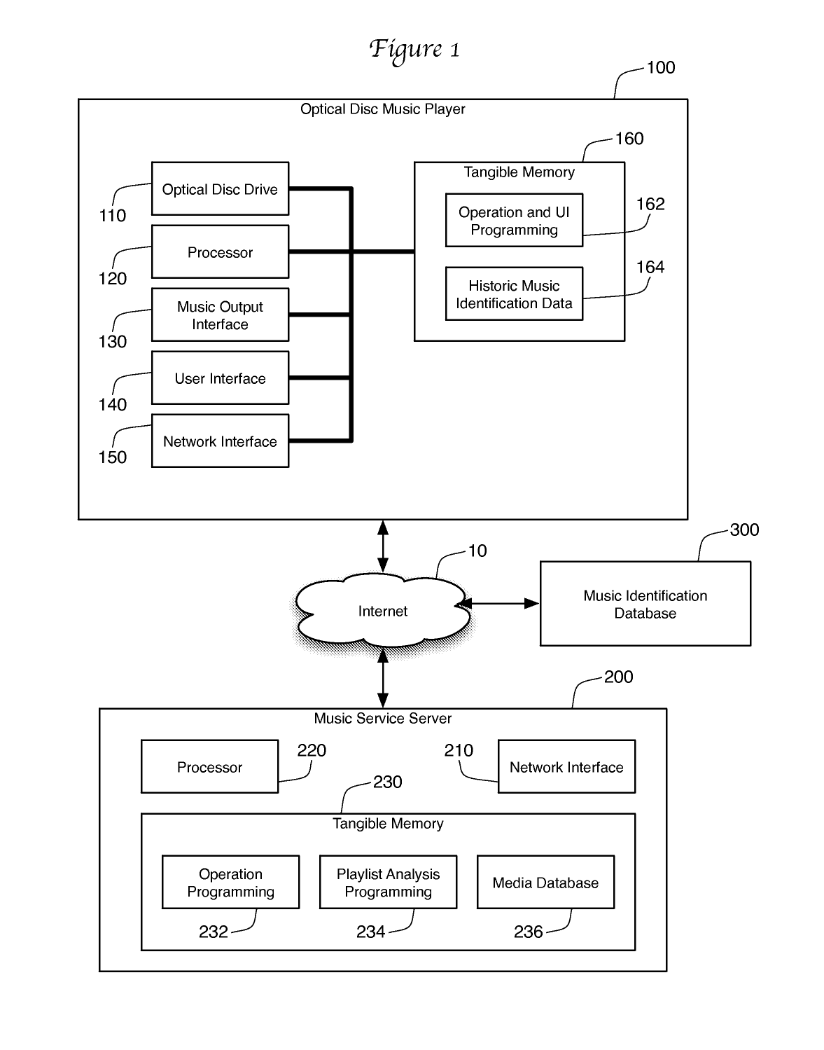

FIG. 1 shows one embodiment of an optical disc music player 100 that communicates with a music service server 200 over a network such as the Internet 10. The music player 100 is specifically designed to read optical discs through an optical disc drive 110. These optical discs may be compact discs (CDs), or other types of optical discs included digital versatile discs (DVDs), DVD-Audio discs, Blu-ray discs, etc. The music on the optical disc read by the optical disc drive 110 is decoded by one or more processors 120, and then output by the music player 100 through a music output interface 130. The music output interface 130 may be one or more analog electrical audio outputs, or optical or electrical digital audio outputs such as those defined by S/PDIF protocol. Although not shown in FIG. 1, it is also possible for the music output interface 130 to include an amplifier and physical speakers so that a user can hear the music on the optical disc without the need to connect the music player 100 to a separate amplifier or speakers. The amplifier and speakers can exist within a single chassis with the other components of player 100, thereby created an “all-in-one” music player 100. Such an all-in-one unit may also include an auxiliary input to allow the receipt of music inputs from outside the unit, and an analog or digital radio tuner to allow the reception and playing of radio content.

The user is able to control the music player through the user interface 140. The user interface 140 can be as simple as a plurality of buttons on one of the faces of the music player 100, or can be as complex as a touch-screen GUI interface operating under the control of processor 120. It is to be expected that the user interface 140 will also include the ability for the music player 100 to be operated remotely, such as through an infrared or radio frequency remote control. Since the music player 100 also includes a network interface 150, the remote control can be a networked device such as a computer or a smart phone running a remote control application. The network interface 150 can take the form of a wired network interface (such as a gigabit Ethernet port) or a wireless network interface (such as a Wi-Fi or IEEE 802.11 wireless access interface).

The operation of the processor is controlled by programming 162 found in the tangible memory 160 of the optical disc music player 100. Such memory 160 can be any type of standard, tangible memory, including RAM, ROM, PROMs, flash memory, or one or more hard drives, or some combination of these memories. The memory 160 should be persistent, so that the contents of memory 160 persist even without supplying any power to the memory 160. If the processor 120 is a general purpose processor such as a i3 or Atom processor by Intel Corporation (Santa Clara, Calif.), the memory 160 containing programming 162 can be created physically separate from the processor 120. Alternatively, the chip containing the processor 120 may be specifically programmed to operate the music player 100, such as an ASIC or a system-on-a-chip or SoC. In some designs, the processor 120, network interface, and memory 160 may be located on a single integrated circuit. In other words, the separate components forming the music player 100 in FIG. 1 can be combined and separated in any manner known in the prior art without departing from the scope of the present invention.

In addition to the ability to play music found on an optical disc read by disc drive 110, the music player 100 also has the ability to interface to remote servers 200 over the network 10. In the preferred embodiment, this ability is used by the music player 100 to provide a continuous playback functionality. Continuous playback allows a user to insert a single optical disc into drive 110 and have the player 100 respond with a continuous stream of related music. For example, upon receiving a command through user interface 140, the music player would first play the entire content of the optical disc. After all music on the optical disc has been played, the player 100 would continue playing music by automatically streaming related music from the remote music service server 200 over the music output interface 130.

To accomplish this, the music player 10 must extract some identification information from the optical disc and submit this information to the music service server 200 for the generation of a related music playlist. This extracted information could take the form of a calculated disc identifier, such as that used by the CDDB database provided by Gracenote, Inc. (Emeryville, Calif.) or the similar freedb database. Alternatively, the music player 10 may extract the identifiers directly from the optical disc, such as the information provided under the CD-Text format or the embedded metadata defined in the MP3 and AAC formats. The player 100 then submits the identification information via network interface 150 over the network 10 to the music service server 200. If the player 100 extracts the identification information from embedded metadata (i.e., from AAC formatted music on the optical disc), the information could include a variety of information, include the music's genre, artist, album title, track title, or composer. The music player 100 could then select which information it submits to the server 200. In some embodiments, only the artist will be submitted, while in other embodiments, the player 100 will submit album and track titles along with the artist.

It is possible that the music service server 200 will not accept the music identification information taken from the optical disc as an input to its recommendation engine. If the disc does not contain metadata, the identification information may take the form of a long number related to the table of contents for the disc. For example, the identification information used by CDDB1 (and freedb) represents a combination of a checksum based on the starting times of each track on the optical disc, the total duration of the music on the disc in seconds, and the number of tracks on the disc. While this identification information may uniquely identify the music disc, some music service servers 200 require as input an artist name or a track name that is associated with a particular artist. In order to find the artist and track name for music discs that do not contain this information in digital format, one embodiment of the music player 100 uses the identification information extracted from the disc to query a music identification service 300 such as CDDB or freedb in order to obtain the artist, album, and track names. These databases 300 accept table-of-contents-based information as a query input, and return artist, album, and track titles. Once this information is obtained from the music identification database 300, the artist, album, and/or track names are provided to the music service server 200 in order to obtain a stream of related music.

The music server 200 receives the identification information over its network interface 210, and then analyzes the information using processor 220 in order to identify the music being played by the optical disc music player 100. The music service server 200 operates via operation programming 232 that is stored in the tangible memory 230 of the server. In addition to its general operation programming 232, tangible memory 230 includes playlist analysis programming 234. The processor 220 uses this analysis programming 234 to identify various characteristics about the music being played on the optical disc drive 110, and to then use these characteristics to create a playlist of similar songs from its media database 236. There are various algorithms currently within the prior art that are used for analysis programming 234. For instance, Pandora Media, Inc. operates the Pandora media service based on a recommendation engine based on its “Music Genome Project.” This recommendation engine identifies various characteristics of a particular song, including artist gender, beat, and type of background vocals. These individual characteristics are combined into a multi-dimensional vector, and similar songs are computed using a distance vector analysis, as described in U.S. Pat. No. 7,003,515, which is hereby incorporated by reference.

Alternatively, the music service server 200 may provide songs that relate to a single one of the characteristics provided by the player 100. For instance, the Napster music service (by Napster, LLC of Los Angeles, Calif.) plays songs by a single artist on demand. This ability allows the music player 100 to identify the artist from the optical disc, and then request continuous playback of music by the same artist. Since the same service 200 can also play related songs by other artists, the music player 100 can provide the ability for a user to select whether the continuous playback of music will be limited to songs by the same artist, or should include similar songs by other artists. Alternatively, assuming it is supported by the service 200, the user interface 140 of the player 100 can include a slider that moves between “selected artist only” and “similar artists,” much like the slider that is provided by the MOG music service (offered by MOG Inc. of Berkeley Calif.).

Once the music service server 200 has identified the music to be played, the server 200 will use its network interface 210 to stream that music over the network 10 to the music player 100. The processor 120, operating under the control of programming 162, receives this music stream via network interface 150 and presents it to the music output interface 130. In one embodiment, this stream of music will begin as soon as the last music on the optical disc is played over the music output interface 130. In this way, the player 100 presents a continuous stream of music to the user simply upon the playing of a single optical disc on the optical disc drive 110.

The music service server 200 preferably has the ability to pause and unpause the music stream. Users of the optical disc music player 100 can use the same user interface features 140 provided to pause and unpause the playing of the optical disc in drive 110 to control this music stream. For instance, when the user pushes the pause button on the user interface 140, the player 100 will receive this command and issue an appropriate pause command to the music service server 200. Other commands, such as to unpause a paused music stream or to skip a particular song, would be handled similarly.

Some music service servers 200 require that each user identify themselves to the server 200 before the service can be utilized. In these embodiments, the operation programming 162 of the music player 100 will establish an account with the server 200. This account can be based on user information that is supplied by the user and stored in tangible memory 100. Alternatively, the music player 100 will use a unique identifier such as a serial number that is stored in the tangible memory 160 upon construction of the device 100. This unique identifier is then used to identify the music player 100 to the music service server 200.

In some embodiments, the music service server 200 is unaware of the existence of music players such as player 100. In these embodiments, the programming 162 must be able to establish an account with the music service server 200 in the same manner as a new human user would using a web browser. While this type of programming is relatively simple to implement, it would be difficult to develop programming 162 that would be flexible enough to handle changes to the user interface and login routines implemented by the owners of the music service server 200. To avoid such complications, another embodiment includes an automated system that allows the music player 100 to log into the music service server 200 without emulating a human user's interaction with the server 200 through a web browser. For instance, a contractual arrangement can exist between the manufacturers of the music player 100 and the operator of the music service server 200 to grant access to the server 200 to the player 100. This arrangement can include the ability for the music player 100 to implement the service provider's API in order to login and control the service provided by the music service server 200 directly without the need to emulate a human user.

One benefit of this embodiment is that users of a device as simple as a CD player are able to access a music service server 200 to provide streaming music service over their home music system. There is no need to set up and select among separate “channels” with the music service server 200 in order to listen to different types of music. All that is necessary is that the user inserts a desired CD into the music player 200 and the player 200 will do the rest. If a different type of music is desired, a different CD can be inserted into the music player 200. Without the disclosed embodiment, a user would need to be sophisticated enough to use a computer or smart phone to access the music service server 200, seed the server with a selected song or artist, and then attach their computer or smart phone to their home music system.

In one embodiment, the optical disc inserted into the music player 100 must play completely before the related music stream from server 200 will begin playing over the music output interface 130. For this to occur, the player 100 anticipates the end of the music on the optical disc, and requests the related music stream from the music service server 200 at the appropriate time so that the music continues uninterrupted. Alternatively, the music player 100 can use the “pause” capabilities of the music service server 200 to pause the music stream until the exact moment the optical disc completes its playing. The stream is then unpaused to create a continuous music experience for the user. In other embodiments, once the user inserts the optical disc into drive 110 and the player 100 identifies the disc, the user can elect to skip playing of the actual optical disc and directly begin playing the related music stream from the music service server 200.

In yet another embodiment, the information used to identify the optical disc to the music service server 200 can be stored in the tangible memory 160 of the music player as historic music identification data 164. In this embodiment, the user can select prior music discs previously inserted into the optical disc drive 110 and use this information to seed the music streaming provided by the music service server 200. In this way, the user can select a previously played disc to start a new music stream from the server 200 without physically reinstalling that disc into drive 110.

Alternatively, assuming the API of the music service server 200 supports the memorization of separate channels on the player 100, these channels could be stored as the historic music identification data 164. One benefit of using stored channels as the data 164 stored in memory 160 is that users can customize channels to their taste and improve these customizations over time. In other words, once the player 100 begins receiving a music stream based on a particular optical disc, the user can indicate whether they like or dislike a particular song using user interface 140. These preferences can be sent back to the server 200 over network 10, which allows the server 200 to customize music stream according to the customer's tastes. The server 200 memorizes these customized music streams as individual “channels” for that user. In one embodiment, the player 100 stores identifiers for these channels in memory 164, and then allows the user to select these channels at a later time for later playback of the same music stream. Without the ability to recall channels created by the server 200, the player 100 could only resubmit the same disc identification information each time the user inserted the disc (or selected the disc from memory 164), and the user's previous customization for that stream will be lost.

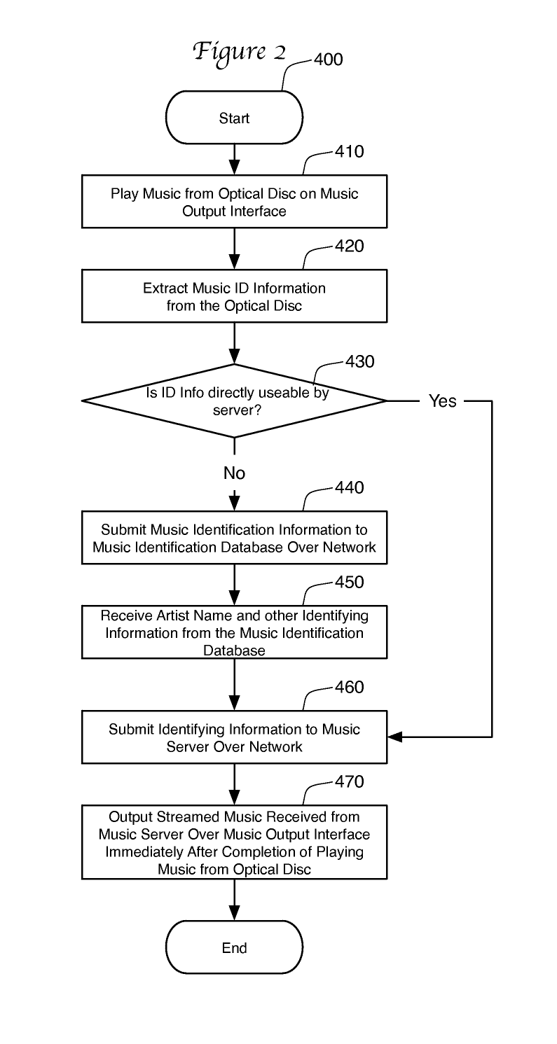

FIG. 2 shows a flow chart that describes the method 400 used by one embodiment of the present invention. The first step 410 of the method is to play the music found on an optical disc that has been inserted into drive 110 over the music output interface 130. While playing this music (or immediately before or after), music identification information is extracted from the optical disc in step 420. In the preferred embodiment, this step can occur using a variety of techniques. For instance, if the disc contains metadata such as CD-Text or AAC or MP3 tags, that information is directly retrieved at step 430. If this information is not available, then 430 can create a numerical construct such as by using the algorithm based on the disc's table of contents as preferred by the CDDB1 protocol.

This identification information may be immediately usable by the remote music service server 200 to create a new music stream. For instance, the server 200 could directly use numeric information created from the disc's directory structure to identify the disc, or the disc may contain textual data that can be used by the server. If the identification info is not useable by the server (as determined by step 430), this ID info is submitted to a music identification database 300 over network 10 at step 440. The identification database 300 responds with information that can be used by the server 200, such as the artist and album name and song titles. This information is received by the music player 100 at step 450, and is then submitted to the music server 460 over the network 10 at step 460. If step 430 determines that the information retrieved from the disc is usable by the server 200, steps 440 and 450 are skipped and the information is submitted directly at step 460.

At step 470, the server 200 has received the identification information and has begun streaming a related music stream to the player 200. Step 470 receives this stream and outputs the music over the music output interface 130. As shown in FIG. 2, the disclosed embodiment waits for the optical disc to complete its playing before the music stream is output over interface 130. This can be accomplished by proper timing of the submission at step 460, or by the pause/unpause features provided by the server 200, as described above.

In other embodiments, step 470 would allow the playing of the music stream over the output 130 even if the optical disc has not been completely played by the player 100. As suggested above, the user can set a preference or interact with the user interface 140 to instruct the player 100 to initiate the music stream even though the disc has not completely played.

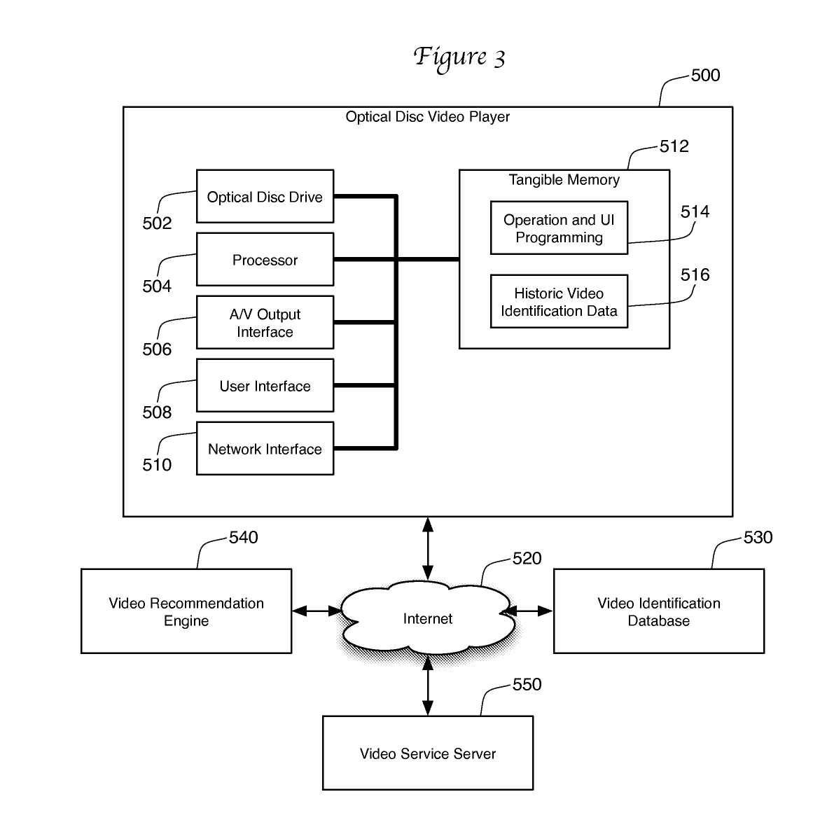

FIG. 3 shows another embodiment of the present invention, this time in the form of an optical disc video player 500. This video player 500 operates like the music player 100, in that the video player 500 identifies an optical video disc (such as a DVD or Blu-ray disc) inserted into the player, and uses that identification to provide related content that is streamed over the Internet 520 from a video service server 550.

The video player 500 has an optical disc drive 502, a processor 504, an output 506 to output the content extracted by the optical disc drive 502, a user interface 508, a network interface 510, and tangible memory 512. The optical disc drive 502 extracts both video and audio content from the optical disc, which means that the output interface 506 must be capable of presenting both video and audio content. This can be accomplished by incorporating a video screen and speakers as part of the video player 500 itself. Alternatively, the player 500 could include analog or digital audio/video outputs that send the content to compatible external devices.

The tangible memory 512 contains operating and user interface programming 514 that allows the user to control the operation of the optical disc video player 500. Memory 512 also contains historic video identification data 516, which operates much like the historic music identification data 164 described above in conjunction with FIG. 1.

Like the music player 100, the optical disc video player 500 extracts identifying information from the video disc inserted into optical disc drive 502. This identifying information may not be in a form that is easily understood by the video service server 550. In these circumstances, this identifying information is first submitted to a video identification database 530, such as the VideoID database provided by Gracenote, Inc. (Emeryville, Calif.). The video identification database 530 takes the information extracted from the disc, looks up the information for that disc in its database, and returns useful metadata about the identified optical disc. Example metadata for an optical disc containing a feature movie might contain the movie's title, release year, and rating, as well as the actors who star in the movie.

In some circumstances, this metadata can be submitted directly to the video service server 550 to request the streaming of related video content. In other circumstances, the video metadata is sent to a separate video recommendation engine 540 over the Internet 520. This engine 540 receives the metadata, and determines a plurality of ranked video options available at the video service server 550. The ranked list of video options is returned from the recommendation engine 540 to the video player 500, which then requests the streaming of the first video option from the video service server 550. The video material is then sent to the optical disc video player 500, which then outputs that video stream over its A/V output interface 506. Once this stream is complete, the player 500 can request the next content in the ranked list received from the recommendation engine 540.

As a result, the video player 500 is able to provide continuous playback of video material by using the inserted video disc as a seed to select additional content from the video service server 550. If the user pauses playback of the video stream (such as by hitting the pause button or shutting down the video player 500), the player 500 will remember the user's location in the video stream and begin playback at that location when requested by the user. In another embodiment, instead of streaming the highest rated show returned by the recommendation engine 540, the user interface 508 may give the user an ability to select one of a plurality of programs that are included in the list returned by the recommendation engine 540.

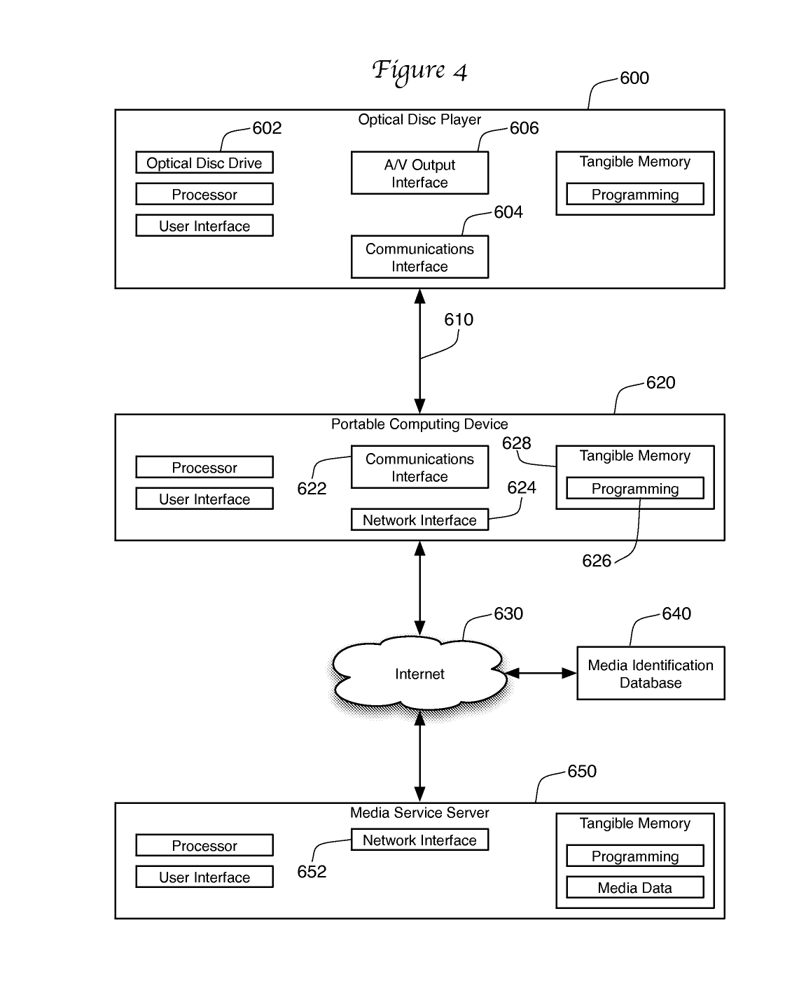

FIG. 4 shows yet another embodiment of the present invention. In this embodiment, an optical disc player 600 includes an optical disc drive 502 to receive audio or video optical discs. This player 600 differs from the music player 100 and the video player 500 in that this player 600 does not include a TCP/IP network interface that allows direct communication over the Internet. Instead, the player 600 uses a different communications interface 604 to establish connection 610 to a portable computing device 620. In one embodiment, this connection 610 is a Bluetooth, short-range wireless connection. The Bluetooth communications interface 604 establishes the connection 610 with a corresponding Bluetooth interface 622 in the portable computing device 620.

This embodiment is particularly useful in mobile communications settings, such as in a motor vehicle. In this context, the optical disc player 600 may be an automobile stereo head unit, which has a Bluetooth connection 610 to a cellular telephone acting as the portable computing device 620. Although the head unit 600 does not have the ability to communicate over the Internet 630, the telephone 620 does have this ability through its TCP/IP network interface 624. In effect, the disc player 600 makes up for its lack of an Internet network interface by using the network interface 624 of a Bluetooth connected telephone 620. In this way, the optical disc player 600 will have access to a media identification database 640 and a media service server 650. The portable computing device 620 uses application programming (i.e., an “app”) 626 stored in tangible memory 628 to handle data communications between the Bluetooth communications interface 622 and the Internet network interface 624.

When the disc player 600 receives an optical disc in its disc drive 602, it will extract identifying information from the disc. If the player 600 is connected to a portable computing device 620, it will request that the device submit the identifying information over the Internet 630 to the media identification database 640. The device 620 will accept and act on this request using programming 626. The identifying information will be submitted to the identification database 640, which will return understandable metadata about the content of the optical disc. At this point, this metadata is used either by the optical disc player 600 or the app 626 operating on the portable computer device 620 to submit a request to the media service server 650 to begin streaming related content. The related content will then be streamed from the media service server 650 over the Internet 630 to the portable computing device, which will in turn submit the content over the connection 610 to the optical disc player 600. The disc player can then play the media stream over its output interface 606, thereby providing a continuous stream of content based upon the content of the optical disc inserted into the optical disc drive 602.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. An optical disc player comprising:
a) an optical disc drive that receives an optical disc containing particular music;
b) a music output interface to output the particular music;
c) a communication interface in communication with a remote music service server over a network;
d) a processor in data communication with the optical disc drive and the communication interface; and
e) a tangible memory storing programming that is implemented by the processor to:
i) extract identifying information for the particular music from the optical disc;
ii) submit the identifying information over the communication interface to the remote music service server;
iii) receive a music stream related to the particular music over the communication interface from the remote music service server;
iv) output the music stream over the music output interface.

2. The optical disc player of claim 1, wherein the communication interface is a network interface communicating directly with the remote music service server over the Internet.

3. The optical disc player of claim 1, wherein the music output interface is an analog audio output port.

4. The optical disc player of claim 1, wherein the music output interface is a digital audio output port.

5. The optical disc player of claim 1, wherein the music output interface comprises an amplifier and at least one speaker.

6. The optical disc player of claim 1, wherein the communication interface is a wireless interface.

7. The optical disc player of claim 6, wherein the wireless interfaces implements an IEEE 802.11 protocol.

8. The optical disc player of claim 1, wherein the programming in the tangible memory further causes the processor to:
i) submit the identifying information to a music identification database over the communication interface,
ii) receive metadata from the music identification database, and
iii) submit at least a portion of the metadata received from the music identification database over the communication interface to the remote music service server.

9. The optical disc player of claim 1, wherein the processor does not output the music stream over the music output interface until after all of the particular music on the optical disc is output over the music output interface.

10. The optical disc player of claim 1, further comprising a user interface including an input that determines whether the music stream is output over the music output interface before all of the particular music on the optical disc is output over the music output interface.

11. The optical disc player of claim 1, further comprising historic music identification memory containing an historic music identifier that identifies to the remote music service server a previously identified music stream.

12. The optical disc player of claim 1, wherein the communication interface is a Bluetooth interface communicating to a portable computing device, further wherein the portable computing device contains a network interface communicating directly with the remote music service server over the Internet.

13. The optical disc player of claim 12, wherein the programming in the tangible memory further causes the processor to:
i) submit the identifying information over the communication interface to the portable communication device in order for the portable communication device to forward the identifying information to a music identification database,
ii) receive via the portable communication device metadata that originated at the music identification database, and
iii) submit at least a portion of the metadata received from the music identification database over the communication interface to the remote music service server via the portable communication device.

14. The optical disc player of claim 12, wherein the processor does not output the music stream over the music output interface until after all of the particular music on the optical disc is output over the music output interface.

15. A method of streaming music data over music output interface comprising:
a) receiving an optical disc containing particular music on an optical disc drive;
b) outputting the particular music over the music output interface;
c) determining an identity for the optical disc;
d) submitting the identity of the optical disc to a remote music service server over a network interface;
e) receiving a related music stream from the remote music service server, the related music stream being related to the particular music on the optical disc; and
f) outputting the related music stream over the music output interface.

16. The method of claim 12, wherein the step of determining the identity of the optical disc further comprises:
i) extracting content information about the contents of the optical disc from the optical disc,
ii) submitting the content information to a music identification database over the network interface, and
iii) receiving the identity of the optical disc from the music identification database over the network interface.

17. The method of claim 12, wherein the step of outputting the related music stream occurs immediately after all of the particular music on the optical disc is output over the music output interface.

18. The method of claim 12, wherein the step of outputting the related music stream does not occur until after at least a portion of the particular music on the optical disc is outputted over the music output interface.

19. The method of claim 18, wherein the step of outputting the related music occurs under the control of a user interface.

20. An optical disc player comprising:
a) an optical disc drive that receives an optical disc containing particular media content;
b) an audio/visual output interface to output the particular media content on the optical disc;
c) a communication interface in communication with a remote media service server over a network;
d) a processor in data communication with the optical disc drive and the communication interface; and
e) a tangible memory storing programming that is implemented by the processor to:
i) extract identifying information for the particular media content;
ii) submit the identifying information over the communication interface to the remote media service server;
iii) receive a media stream related to the particular media content over the communication interface from the remote media service server;
iv) output the media stream over the audio/visual interface.
